(19) United States
(12) Patent Application Publication
(10) Pub. No.: US 2026/0339082 A1
(43) Pub. Date: Oct. 29, 2026

(54) LENS DRIVING DEVICE, CAMERA AND ELECTRONIC DEVICE

(71) Applicant: XIAMEN ZHONGHUI MICROELECTRONICS CO., LTD, Xiamen (CN)

(72) Inventors: Chaochon Chang, Taibei (CN); Xiaoxiong Luo, Xiamen (CN)

(21) Appl. No.: 19/657,335

(22) Filed: Apr. 24, 2026

(30) Foreign Application Priority Data
Apr. 29, 2025 (CN) 202510556096.8

(51) Int. Cl. G02B 13/00; G02B 7/10; G03B 5/02; G03B 17/12; G03B 17/17; G03B 30/00

(52) U.S. Cl. CPC G02B 13/009; G02B 7/10; G03B 5/02; G03B 17/12; G03B 17/17; G03B 30/00; G03B 2205/0046; G03B 2205/0069

(57) ABSTRACT

A lens driving device includes a housing, a first carrier received in the housing and configured for holding a first lens unit, and a first driving unit configured for driving the first carrier to move along an optic axis of the first lens unit. The housing includes: a top plate defining a first opening, a bottom plate, and a plurality of side plates connecting the top plate and the bottom plate. A first side plate of the plurality of side plates defines a second opening to allow a part of a reflective lens to be inserted through the second opening and positioned below the first lens unit. The introduction of the reflective lens and its corresponding clearance design in the lens driving device effectively reduce the height of the lens driving device. This optimization improves product applicability and market competitiveness.

### CROSS-REFERENCE TO RELATED APPLICATION

The present application claims priority of China Patent Application No. 202510556096.8, filed on Apr. 29, 2025, the contents of which are incorporated herein by reference.

### BACKGROUND OF THE INVENTION

### Technical Field

The present application relates to lens driving devices, and in particular to a lens driving device, camera and electronic device having the lens driving device.

### DESCRIPTION OF RELATED ART

Cameras integrated into electronic devices such as mobile phones, portable tablets, and notebooks typically include both front and rear cameras for capturing images. Telephoto camera has gained widespread popularity due to its distinct advantages, such as capturing distant scenes (e.g., landscapes, animals, architectural details) and creating portrait photos with a compressed spatial perspective (bringing the background closer while highlighting the subject). Telephoto cameras require a relatively long physical focal length, which often results in a thicker lens module. However, the thickness of portable electronic devices is highly constrained. To address this, current telephoto cameras commonly adopt a periscope structure. However, the thickness of current periscope camera remains relatively large.

### SUMMARY OF THE INVENTION

An objective of the present invention is to provide an improved lens driving device, camera and electronic device having the lens driving device.

The lens driving device at least includes a housing, a first carrier received in the housing and configured for holding a first lens unit, and a first driving unit configured for driving the first carrier to move along an optic axis of the first lens unit. The housing includes: a top plate defining a first opening, a bottom plate, and a plurality of side plates connecting the top plate and the bottom plate. A first side plate of the plurality of side plates defines a second opening to allow a part of a reflective lens to be inserted through the second opening and positioned below the first lens unit.

The introduction of the reflective lens and its corresponding clearance design in the lens driving device effectively reduce the height of the lens driving device. This optimization improves product applicability and market competitiveness.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is front view of an electronic device in accordance with a first embodiment of the present invention.

FIG. 2 is a back view of the electronic device in FIG. 1.

FIG. 3 is a perspective view of a camera having a lens driving device, a catadioptric lens and an image sensor device in accordance with the first embodiment of the present invention.

FIG. 4 is an A-A cross-sectional view of the camera in FIG. 3.

FIG. 5 is an exploded view of the lens driving device in FIG. 3.

FIG. 6 is an exploded view of the lens driving device in FIG. 3 from another perspective.

FIG. 7 is a perspective view of the lens driving device in FIG. 3.

FIG. 8 is a cross-sectional view of the lens driving device in FIG. 3.

FIG. 9 is a schematic diagram of a magnet unit arranged in a Halbach array.

FIG. 10 is an exploded view of a lens driving device in accordance with a second embodiment of the present invention.

FIG. 11 is an exploded view of a lens driving device in accordance with a third embodiment of the present invention.

### DETAILED DESCRIPTION OF THE INVENTION

The invention will now be described in detail through several embodiments with reference to the accompanying drawings.

### First Embodiment

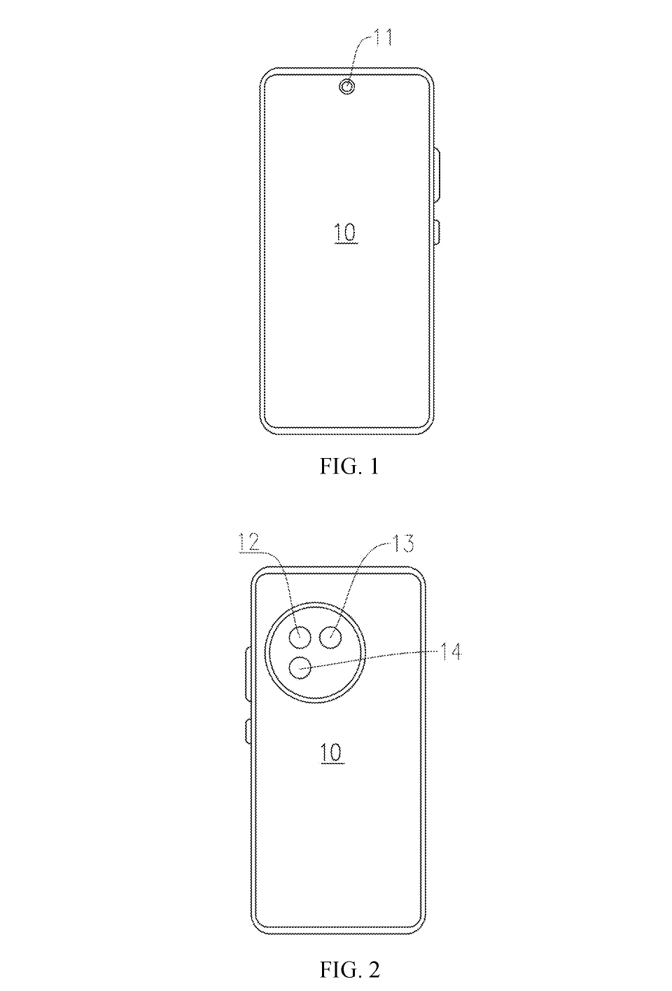

An electronic device in the embodiment may include at least one camera for taking photos or recording. The electronic device may be a mobile phone, a personal digital assistant (PDA) computer, a tablet computer, a laptop, a laptop computer, a smart watch, a smart wristband, an in-vehicle computer, or a television. For example, please refer to FIGS. 1 and 2, an electronic device 10 is a mobile phone having a front camera 11 and three back cameras 12, 13 and 14. The front camera 11 and the back camera 12 may be wide cameras (main cameras), the back camera 13 may be an ultra-wide camera or a wide-angle camera, and he back camera 14 may be a telephoto camera with a longer focal length than the wide cameras.

The periscope telephoto camera 14 may use a catadioptric lens to bend light at a preset angle, allowing for a longer focal length to be housed horizontally within the slim body of the electronic device, enables users to bring faraway objects closer for shooting. This hardware-based design accomplishes true, lossless optical zoom.

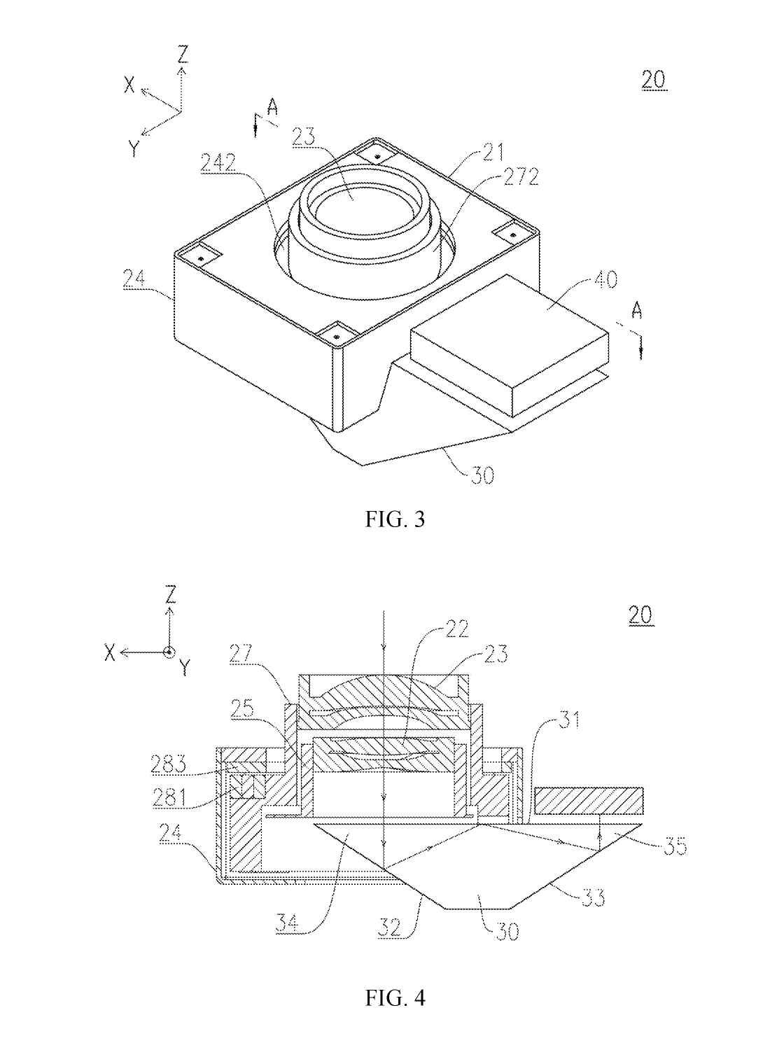

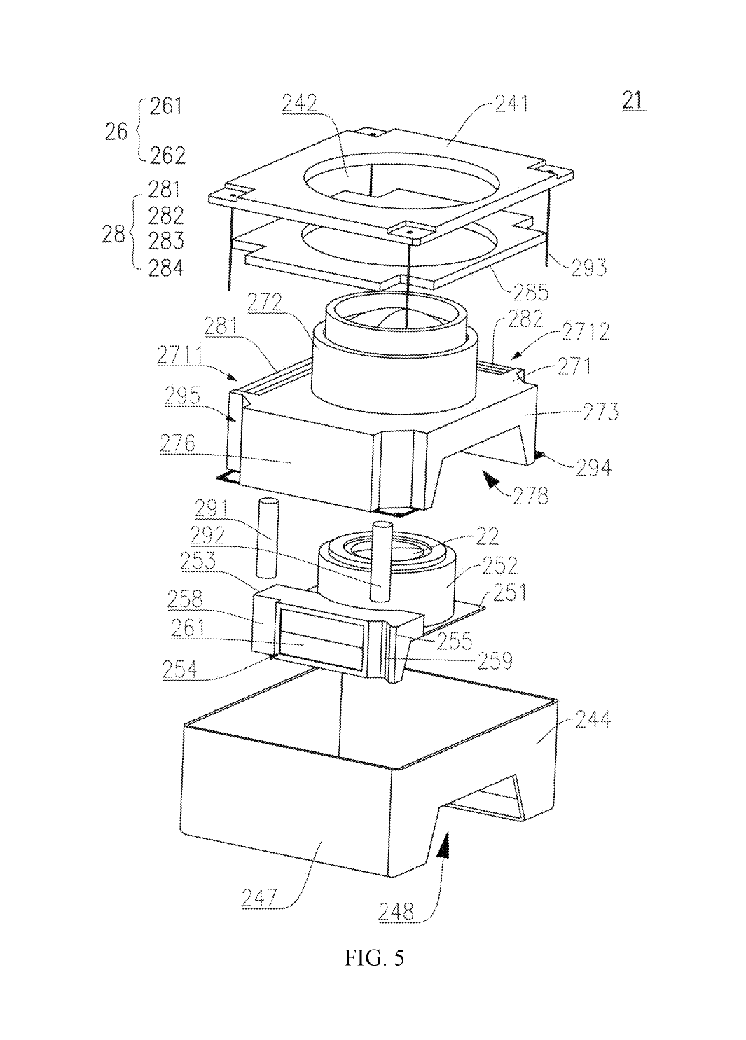

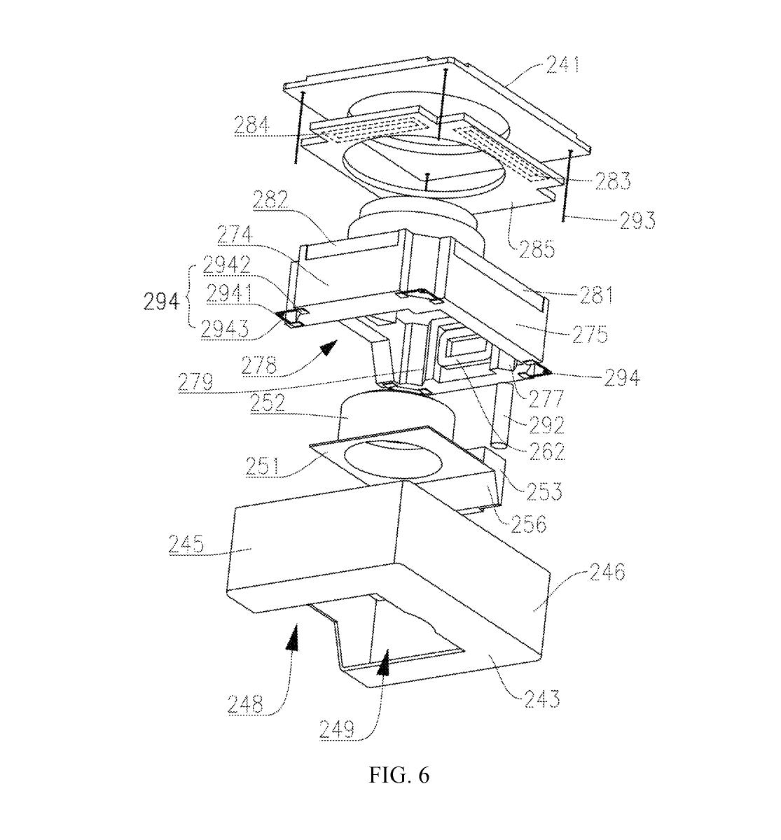

FIG. 3 illustrates a perspective view of a camera 20 having a lens driving device 21, a catadioptric lens 30 and an image sensor device 40 in accordance with an embodiment of the present invention. FIG. 4 illustrates an A-A cross-sectional view of the camera 20 in FIGS. 3, 5 and 6, illustrate exploded views of the lens driving device 21. Lines with arrowheads are used to represent light rays and their direction of propagation in FIG. 4.

For the convenience of describing the configuration of the camera 20, in the following description, a three-dimensional (3D) Cartesian coordinate system is introduced. The optical axis is parallel with a Z-axis of the 3D Cartesian coordinate system. The subject being photographed by the camara 20 is considered to be located in the +Z side of the Z axis direction (+Z-axis side).

The camera 20 may be used as the periscope telephoto camera 14 of the electronic device 10. The catadioptric lens 30 is designed to bend incident light by 180 degrees by reflecting vertically incoming light at least twice before it exits vertically. In the longitudinal cross-section of the catadioptric lens 30, which is trapezoidal in shape, the base 31 (the longer parallel side) serves as both the entrance and exit surface for the light. The two non-parallel sides 32, 33 (the legs) of the trapezoidal cross-section function as the reflective surfaces of the catadioptric lens 30. For ease of description, the junction where the base (the bottom side of the trapezoidal cross-section) meets each of the legs is referred to as a corner. Accordingly, the catadioptric lens 30 features two such corners 34, 35.

The lens driving device 21 is used for carrying a first lens units 22, a second lens unit 23 and receiving a part of the catadioptric lens 30, in the embodiment, more than a half (including the corner 34) of the catadioptric lens 30 is received in inner side of the lens driving device 21. Each of the first lens units 22 and the second lens unit 23 may include one or two or two more spherical or aspherical lenses having positive or negative refractive power.

The lens driving device 21 mainly includes a housing 24, a first carrier 25, a first driving unit 26, a second carrier 27 and a second driving unit 28.

The housing 24 mainly includes a top plate 241 defining a first opening 242, a bottom plate 243 and plural side plates connecting the top plate 241 and the bottom plate 243. In the embodiment, the housing 24 has a substantially cuboid shape, therefore has four side plates 244, 245, 246, 247.

The first side plate 244 defines a second opening 248 to allow a part of the reflective lens 30 to be inserted through the second opening 248 and positioned below the first lens unit 22. The bottom plate 243 defines a third opening 249 in communication with the second opening 248 to allow a lower part (including the top base, that is the shorter parallel side of the trapezoidal cross-section) of the reflective lens 30 to protrude out of the housing 24. It is understandably, when a height of the reflective lens 30 is low enough, it third opening 249 may be omitted.

The housing 24 may be made of non-conductive metals, such as stainless steel, or plastic.

The first carrier 25 is received in the housing 24 and used for holding the first lens unit 22 and a part of the first driving unit 26. The first carrier 25 may be made of plastic, and mainly includes a connecting plate 251, a first lens barrel 252 and a side fixing portion 253. The reflective lens 30 is a thin, substantially square plate perpendicular to the optical axis of the first lens unit 22. The first lens barrel 252 extends upwardly from the connecting plate 251 and toward the top plate 241 of the housing 24, and is used for holding the first lens unit 22. The side fixing portion 253 is formed by extending upward and downward from one side edge of the connection plate 251, respectively. A recess 254 is formed on an outer surface 255 of the side fixing portion 253. The first driving unit 26 is a voice coil driving unit, and includes a first magnet unit 261 and a first coil unit 262. The first coil unit may include one or two or two more electrical coils connected electrically in series or in parallel. The first magnet unit may include two flat permanent magnet pieces arranged side by side in the Z-axis direction with opposite magnetic poles. In this embodiment, the first magnet unit 261 is fixed within the recess 254 on the side fixing portion 253.

Once inserted into the second opening 248, a part of the reflective lens 30 is positioned below the connection plate 251 and adjacent to a lower inner surface 256 of the side fixing portion 253. The upper inner surface 257 of the side fixing portion 253 is adjacent to the first lens barrel 252.

Accordingly, in the camera 20 of the present application, the reflective lens 30 is positioned below the thin connecting plate 251, the first lens unit 22 is positioned above the connection plate 251, and the first driving unit 26 is located on one side of both the first lens unit 22 and the reflective lens 30. Consequently, the height of the first driving unit 22 in the direction of the optical axis does not affect the overall height of the camera 20, facilitating the realization of a slim and compact camera design, and simultaneously achieves a long optical path.

The second carrier 27 is received in the housing 24, and is used for holding the second lens unit 23 and receiving a part of the first carrier 25. The second carrier 27 may be made of plastic, and mainly includes a base plate 271, a second lens barrel 272 extending upwardly from the base plate 271, and plural side fixing portions extending downward from the base plate 271. In the embodiment, the base plate 271 is a substantially square plate perpendicular to the optical axis of the second lens unit 23, therefore there are four side fixing portions 273, 274, 275, 276.

The second lens barrel 272 is used for holding the second lens unit 23, and a part of the second lens barrel 272 may protrude out of the first opening 242 of the housing 24.

The four side fixing portions 273, 274, 275, 276 and the base plate 271 form a receiving space receiving the first carrier 25, and an upper part of the first lens barrel 252 is movably inserted in the second lens barrel 272. The optical axis of the first and second lens units 22, 23 are coaxial, or in other words, the optical axis of the first lens unit 22 is coincident with the optical axis of the second lens unit 23, or in other words the optical axis are on a straight line.

The side fixing portion 273 (second side fixing portion) of the four side fixing portions 273, 274, 275, 276 defines a fourth opening 278 corresponding to the second opening 248. The fourth opening 278 allows a part of the reflective lens 30 to be inserted.

The first coil unit 262 of the first driving unit 26 is fixed to the side fixing portion 276 (third side fixing portion), the first magnet unit 261 and the first coil unit 262 are opposite to each other with space. The first driving unit 26 is used for driving the first carrier 25 to move along the optic axis of the first lens unit 22. That is, the first carrier 25 serves as an auto focus module.

For supporting the movement of the first carrier 25, the lens driving device 21 further includes a guide unit 29 configured between the side fixing portion 276 of the second carrier 27 and the side fixing portion 253 of the first carrier 25 to provide guidance for the movement of the first carrier 25.

In the embodiment, the guide unit 29 includes two posts 291, 292. An outer surface of the side fixing portion 253 of the first carrier 25 defines two first grooves 258, 259 besides the recess 254. The two posts 291, 292 are engaged in the two first grooves 258, 259 that serve as guide channels for movement along the optic axis of the first lens unit 22.

An inner surface of the side fixing portion 276 defines two second grooves 277, 279 corresponding to the first grooves 258, 259, respectively. And each of the two posts 291, 292 is engaged in one of the two first grooves 258, 259 and one of the second grooves 277, 279, respectively. There may be a magnetic metal sheet fixed in the side fixing portion 276 or fixed between the side fixing portion 276 and the first coil unit 262. Therefore, the two posts may be clamped between the side fixing portion 276 of the second carrier 27 and the side fixing portion 253 of the first carrier 25.

In operation, when the first coil unit 262 (the first driving unit 26) is energized, the first magnet unit 261 is actuated to move toward the +Z side or the -Z side and the first carrier 25 moves along, depending on the posts 291, 292 and the two first grooves 258, 259, the first carrier 25 taking the first lens unit 22 together moves along the optical axis, thus the autofocus function and zoom function may be achieved.

As the key guiding mechanism in the lens driving device 21, the posts 291, 292 possess significant and undeniable advantages. From a mechanical structural principle perspective, they effectively maintain a highly precise perpendicularity between the first carrier 25 and the second carrier 27 throughout the entire focusing process. This characteristic is crucial for ensuring that light travels accurately along the predetermined optical axis, as any minor deviation in perpendicularity could cause the light path to shift, thereby affecting imaging clarity and accuracy.

Simultaneously, the posts 291, 292 play a central role in ensuring motion stability. When the first driving unit 26 drives the first carrier 25 to move axially along the posts 291, 292, the posts, by virtue of their rigid structure and well-designed sliding fit with the first carrier 25, significantly reduce unstable factors such as shaking and vibration during the movement. This stable motion state is decisive for achieving precise focusing operations. The posts 291, 292 may be made of metal or plastic, and may be fixed to a lower surface of the base plate 271 of the second carrier 271.

The second carrier 27 serves as an OIS (optical image stabilization) module. The second driving unit 28 is configured between the second carrier 27 and the housing 21, and is used for driving the second carrier 27 to move perpendicular to the optic axis of the first lens unit 22.

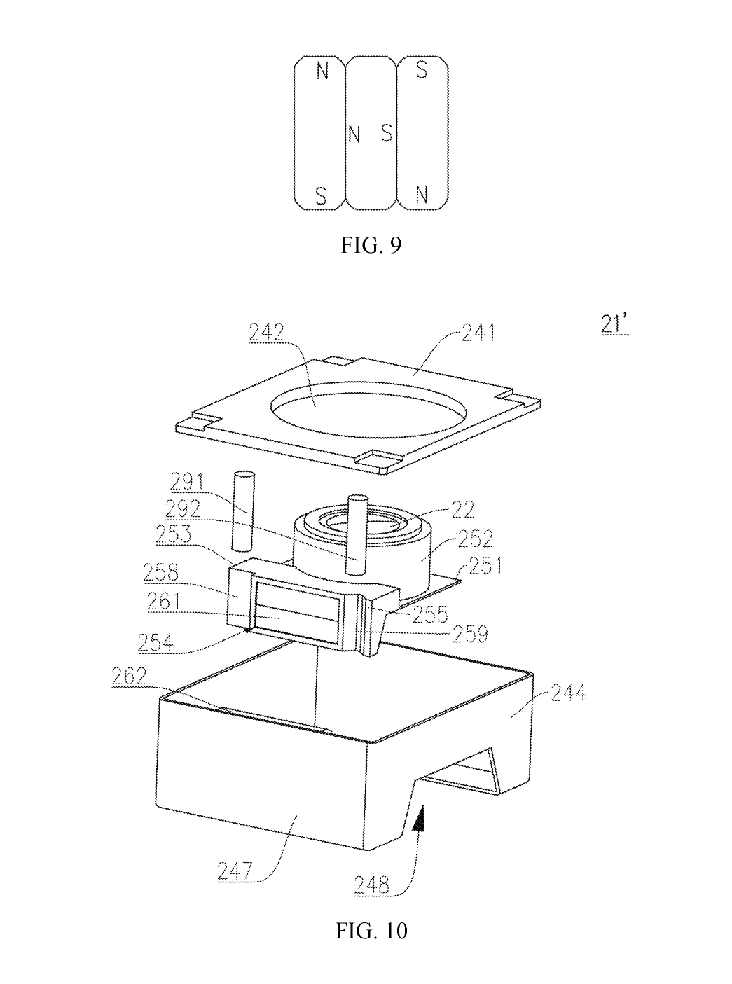

The second driving unit 28 is a voice coil driving unit, and includes a second magnet unit 281, a third magnet unit 282, a second coil unit 283, and a third coil unit 284. Each coil unit may include one or two or two more electrical coils connected electrically in series or in parallel. Each magnet unit may include three flat permanent magnet pieces arranged side by side with opposite magnetic poles (three permanent magnet pieces arranged in a Halbach array, see FIG. 9, with the magnetization direction of each magnet sequentially rotated by 90°).

The second magnet unit 281 and the third magnet unit 282 are fixed to one of the second carrier 27 and the top plate 241 of the housing 24, and the second coil unit 283 and the third coil unit 284 are fixed to the other of the second carrier 27 and the top plate 241 of the housing 24. In this embodiment, the second magnet unit 281 and the third magnet unit 282 are fixed to the second carrier 27, and the second coil unit 283 and the third coil unit 284 are fixed to the top plate 241 of the housing 24.

The second coil unit 283 and the third coil unit 284 are preferably integrally formed in a circuit board 285 which is attached to the top plate 241 of the housing 24. That is, the second coil unit 283 and the third coil unit 284 are planar printed coils, formed as multilayer spiral windings embedded within a flexible printed circuit board. In terms of manufacturing, the planar printed coil utilizes printed circuit board (PCB) technology, simplifying the production process and reducing labor and time costs. Its high-precision printing ensures dimensional accuracy and consistency, improving yield rates, lowering production costs, and enhancing the product's price competitiveness. Regarding space utilization, the flat structure of the planar printed coil saves axial space, contributing to a reduction in the overall height of the lens driving device. Moreover, the planar printed coil can achieve a large inductance within a limited planar area, and the flexible circuit board allows flexible layout design, optimizing spatial efficiency and promoting device miniaturization and integration.

A top surface of the base plate 271 of the second carrier 271 defines two recesses 2711, 2712 configured for receiving the second magnet unit 281 and the third magnet unit 282, respectively. The second magnet unit 281 and the second coil unit 283 opposed to each other with space, and are used for driving the second carrier 27 to move along a first direction (parallel with the X-axis) perpendicular to the optical axis of the first lens unit 22. The third magnet unit 282 and the third coil unit 284 opposed to each other with space, and are used for driving the second carrier 27 to move along a second direction (parallel with the Y-axis) perpendicular to the first direction and the optical axis of the first lens unit 22.

In detail, the second magnet unit 281 is positioned at the front side of the side fixing portion 275, while the third magnet unit 282 is located at the front side of the side fixing portion 274. This configuration means that the second magnet unit 281 is essentially aligned opposite the side fixing portion 275 along the optical axis direction, and the third magnet unit 282 is essentially aligned opposite the side fixing portion 274 along the optical axis direction. Meanwhile, the first coil unit 262 is attached to the side fixing portion 276.

In operation, when the second coil unit 281 is energized, the second magnet unit 282 is actuated to move toward the +X side or the -X side, when the third coil unit 283 is energized, the third magnet unit 284 is actuated to move toward the +Y side or the -Y side, the second carrier 27 moves along together, depending on the magnetic metal sheet fixed in the side fixing portion 276 or fixed between the side fixing portion 276 and the first coil unit 262, the first carrier 25 moves along.

In enhancing magnetic thrust, the application of the Halbach array plays a pivotal role. The Halbach array is a specialized arrangement of permanent magnets, where at least three magnets are positioned according to a specific pattern, with their magnetization directions sequentially rotated by 90°. This configuration generates a significantly stronger magnetic field in a particular direction, thereby substantially increasing the magnetic thrust. Compared to conventional permanent magnet arrangements, the Halbach array can produce several times greater magnetic thrust under the same number and volume of magnets. When shake compensation is required, the second driving unit 28 can drive the second carrier 27 more rapidly and precisely, effectively compensating for displacement deviations caused by external vibrations. This significantly improves the effectiveness of optical image stabilization (OIS), delivering a more stable and clearer imaging experience for users.

For supporting the movement of the second carrier 27, the lens driving device 21 further includes plural linear springs 293 connected between the top plate 241 of the housing 24 and the second carrier 27, and plural, four in the embodiment, plate springs 294 connected to lower ends of the linear springs 293 and lower ends of the side fixing portions. In the embodiment, there are four linear springs 293 and four plate springs 294. The four linear springs 293 are configured for supporting the second carrier 27 to move perpendicular to the optic axis of the first lens unit 22. The four plate springs 294 are mainly used for absorbing vibration energy and protecting the linear springs 293 from broken. The linear springs 293 and the plate springs 294 may be made of metal, such as stainless steel. A plate spring is also commonly known as a leaf spring, is a type of mechanical spring constructed from one or more flat, thin plates (called leaves) stacked together. Its primary function is to store energy under load and release it, providing shock absorption, load bearing, and vibration isolation. The plate springs 294 are substantially perpendicular to the optical axis.

Four recesses 295 are formed at the four corners of the second carrier 27 to provide clearance for the four linear springs 293 that are parallel to the outer surfaces of the side fixing portions 273, 274, 275, 276. An end of each linear spring 293 is connected to a corner of the top plate 241, and the other end of each linear spring 293 is connected to the base plate 271.

The base plate 271 is a substantially square plate perpendicular to the optical axis of the second lens unit 23. Each plate spring 294 may include a first connecting portion 2941 connected to the other end of the linear spring 293, two second connecting portion 2942 and two resilient arms 2943 connected between the first connecting portion 2941 and the second connecting portion 2942. The eight second connecting portions 2942 are connected to lower ends of the four side fixing portions 273, 274, 275, 276. The resilient arms 2943 are capable of recovering their shape after deformation.

During the autofocus/zoom process, the first carrier 25 only needs to move with the first lens unit 22. Therefore, the first driving unit 26 requires only a relatively small driving force to accomplish the autofocus/zoom function. This allows developers to minimize the weight on the side of the first carrier 25 (taking the first lens unit 22 and the first magnet unit 261 together) as much as possible while meeting the optical performance requirements. A lighter first carrier 25 (taking the first lens unit 22 and the first magnet unit 261 together) inherently possesses lower inertia, which means it can achieve faster and more precise positional adjustments with a smaller driving force during the focusing drive. This effectively enhances both focusing speed and accuracy.

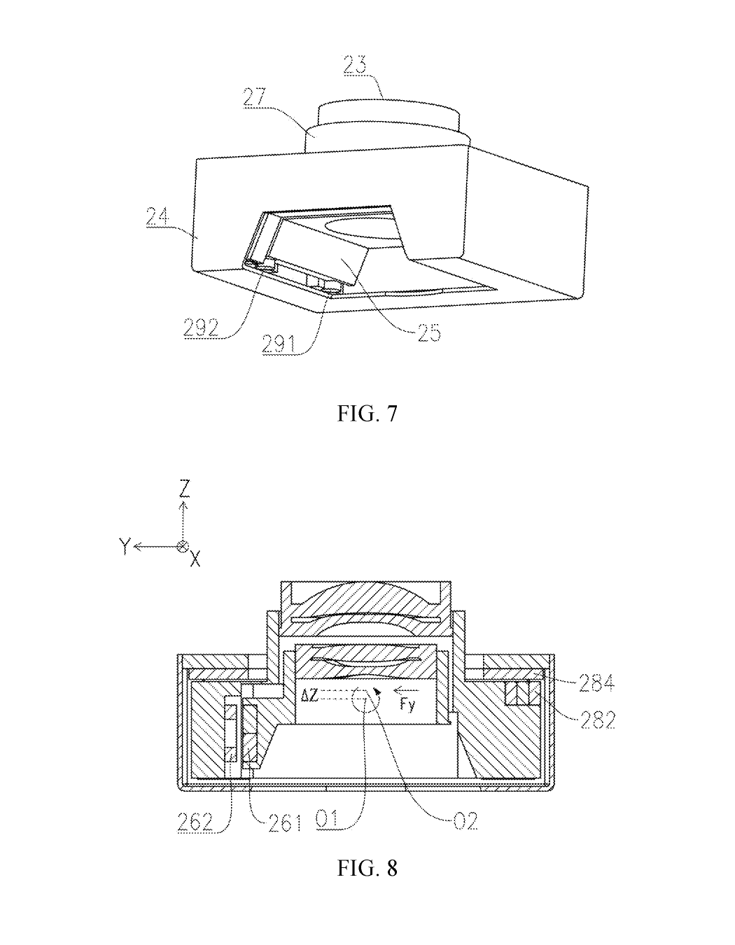

The introduction of the reflective lens 30 with a trapezoidal cross-section (ship-shaped prism) and its corresponding clearance design (see FIGS. 7 and 8 ) effectively reduce the height of the lens driving device 21 and the camera 20 through ingenious spatial arrangement and precise optical engineering. This optimization enhances optical performance, improves product applicability and market competitiveness, and provides new insights and directions for the development of optical focusing technology.

From the perspective of overall structural layout and spatial utilization, the incorporation of the reflective lens 30 aims to achieve efficient integration and optimization of the overall space, with the key objective of reducing the height of the lens driving device 21. In traditional optical device designs, the ship-shaped prism is typically placed outside the lens driving device, which inevitably increases the overall height and hinders the trend toward miniaturization and slimness. In contrast, this invention innovatively embeds the ship-shaped prism inside the lens driving device 21. By creating openings on the optical path side of the components within the lens driving device 21 for clearance, the challenge of spatial arrangement is successfully resolved.

Specifically, the fourth opening 278 set in the sidewall of the second carrier 27, the space inside the side fixing portion 253 of the first carrier 25, and the second opening 248 set in the first side plate 244 of the housing 24 collectively form a clearance space. A portion of the reflective lens 30 can be precisely embedded into this clearance space. This design not only fully utilizes internal space that might otherwise be wasted but also achieves a more compact and orderly spatial relationship among components through rational layout planning. Compared to conventional designs, the overall height of the lens driving device 21 is significantly reduced. This is critically important for meeting the stringent requirements of modern optical devices for miniaturization and integration.

From the perspective of product applicability and market competitiveness, the reduced height of the lens driving device 21 allows this optical focusing module to better fit into various optical devices with strict spatial constraints. Whether in portable electronic devices such as smartphones and tablets, or in specialized optical instruments sensitive to device size and weight, this module stands out due to its compact design and excellent optical performance. This high level of applicability not only broadens the product's range of applications but also significantly enhances its competitiveness in the market, providing strong support for meeting the diverse needs of different customer groups.

In the present application, multiple linear springs 293 are utilized to suspend the second carrier 27 beneath the lower surface of the top plate 241 of the housing 24. The second driving unit 28 is configured to drive the second carrier 27 to move in a direction perpendicular to the optical axis underneath the top plate 241. That is, the optical image stabilization (OIS) mechanism of this application adopts an inverted configuration. This layout reduces an axial spacing (ΔZ, see FIG. 8) along the optical axis between the center of mass (O1) of the optical focusing module (including the first carrier 25, the first lens unit 22, and the first magnet unit 261) and the equivalent force center (O2) of the thrust generated by the second driving unit 28 (the intersection point of the thrust force Fy in the X-axis direction and thrust force Fx in the Y-axis direction), compared to a conventional upright OIS structure. From the perspectives of physical principles and engineering mechanics, this reduction in spacing is of significant importance.

During the image stabilization process, the second driving unit 28 applies thrust to drive the second carrier 27 in a direction perpendicular to the optical axis beneath the top plate 241, thereby achieving stabilization. A smaller spacing (ΔZ) can significantly mitigate adverse effects caused by the stabilization thrust. Most critically, it effectively reduces the lens tilt mode induced by the OIS thrust. Lens tilt can cause deviations in the light path, severely impairing image quality and leading to issues such as blurring and distortion. By minimizing ΔZ, the likelihood of lens tilt is reduced, thereby ensuring that light propagates more accurately along the intended path and substantially improving imaging clarity and precision.

Furthermore, the reduced spacing ΔZ plays a decisive role in increasing the control bandwidth. In an optical image stabilization (OIS) system, control bandwidth is a critical parameter that directly determines the system's ability to respond to vibrations of different frequencies. A higher control bandwidth enables the OIS system to compensate for various vibrations more rapidly and precisely, thereby maintaining effective stabilization performance even under more complex vibration conditions.

By optimizing the distance between the center of mass and the thrust center, the inverted OIS module effectively enhances the control bandwidth. This improvement allows the optical focusing module to respond swiftly under varying vibration frequencies and amplitudes, enabling timely adjustments to the position of the second carrier 27. As a result, the module achieves efficient and stable image stabilization performance.

### Second Embodiment

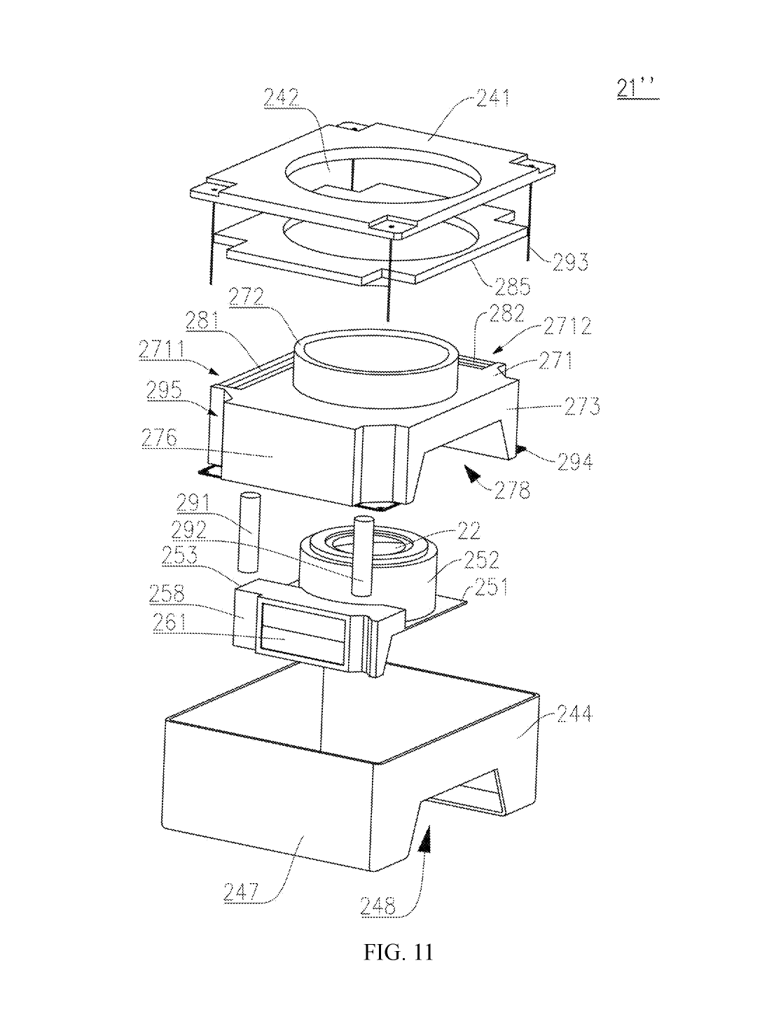

Please refer to FIG. 10, an exploded view of a lens driving device 21’ is shown, and components that share identical structures and functions with those in the first embodiment are designated using the same reference numerals as in the first embodiment. In the second embodiment, the lens driving device 21’ may only have auto focus module. That is, the lens driving device 21’ mainly includes the housing 24, the first carrier 25 and the first driving unit 26. The second carrier 27 and the second driving unit 28 are omitted. The first coil unit 262 may be attached to the side plate 247 of the housing 24 and opposite to the first magnet unit 261 with space. The two posts 291, 292 may be directly fixed to the side plate 247 or the bottom plate 243 of the housing 24.

The lens driving device 21’ may replace the lens driving device 21 in the camera 20 which is installed in the electronic device 10.

### Third Embodiment

Please refer to FIG. 11, an exploded view of a lens driving device 21’’ is shown, and components that share identical structures and functions with those in the first embodiment are designated using the same reference numerals as in the first embodiment. In the third embodiment, the lens driving device 21'’ does not have the second lens unit 23. That is, the lens driving device 21'’ does not have a zoom function.

The lens driving device 21’’ may replace the lens driving device 21 in the camera 20 which is installed in the electronic device 10.

While the invention has been described in terms of several exemplary embodiments, those skilled on the art will recognize that the invention can be practiced with modification within the spirit and scope of the appended claims. In addition, it is noted that, the Applicant’s intent is to encompass equivalents of all claim elements, even if amended later during prosecution.

What is claimed is:

1. A lens driving device, comprising:
a housing;
a first carrier received in the housing and configured for holding a first lens unit; and
a first driving unit configured for driving the first carrier to move along an optic axis of the first lens unit;
wherein the housing comprises:
a top plate defining a first opening;
a bottom plate; and
a plurality of side plates connecting the top plate and the bottom plate;
wherein a first side plate of the plurality of side plates defines a second opening to allow a part of a reflective lens to be inserted through the second opening and positioned below the first lens unit.

2. The lens driving device according to claim 1, wherein the first carrier comprises:
a connecting plate;
a first lens barrel extending upwardly from the connecting plate and configured for holding the first lens unit; and
a side fixing portion formed by extending upward and downward from one side edge of the connection plate, respectively;
wherein once inserted into the second opening, the part of the reflective lens is positioned below the connection plate and adjacent to an inner surface of the side fixing portion.

3. The lens driving device according to claim 2, wherein the bottom plate defines a third opening in communication with the second opening to allow a lower part of the reflective lens to protrude out of the housing.

4. The lens driving device according to claim 2, wherein a recess is formed on an outer surface of the side fixing portion; the first driving unit comprises a first magnet unit and a first coil unit, one of which is fixed within the recess on the side fixing portion.

5. The lens driving device according to claim 4, further comprising a second carrier, comprising:
a base plate; and
a plurality of side fixing portions extending downward from the base plate;
wherein a second side fixing portion of the plurality of side fixing portions defines a fourth opening corresponding to the second opening; the fourth opening allows the part of the reflective lens to be inserted.

6. The lens driving device according to claim 5, wherein the first carrier is moveably configured within a receiving space defined by the base plate and the plurality of side fixing portions.

7. The lens driving device according to claim 5, wherein the other of the first magnet unit and the first coil unit is fixed to a third side fixing portion of the plurality of side fixing portions, the first magnet unit and the first coil unit are opposite to each other with space.

8. The lens driving device according to claim 7, further comprising a guide unit configured between the third side fixing portion of the second carrier and the side fixing portion of the first carrier to provide guidance for a movement of the first carrier.

9. The lens driving device according to claim 8, wherein the guide unit comprises two posts; an outer surface of the side fixing portion of the first carrier defines two first grooves besides the recess, and the two posts are engaged in the two first grooves that serve as guide channels for movement along the optic axis of the first lens unit; the two posts are clamped between the third side fixing portion of the second carrier and the side fixing portion of the first carrier.

10. The lens driving device according to claim 9, wherein an inner surface of the third side fixing portion defines two second grooves corresponding to the first grooves, and each of the two posts is engaged in one of the two first grooves and one of the second grooves, respectively.

11. The lens driving device according to claim 5, further comprising a second driving unit configured for driving the second carrier to move perpendicular to the optic axis of the first lens unit;
wherein the second driving unit comprises a second magnet unit, a third magnet unit, a second coil unit, and a third coil unit;
the second magnet unit and the third magnet unit are fixed to one of the second carrier and the top plate of the housing, and the second coil unit and the third coil unit are fixed to the other of the second carrier and the top plate of the housing.

12. The lens driving device according to claim 11, wherein a top surface of the base plate of the second carrier defines two recesses configured for receiving the second magnet unit and the third magnet unit, respectively.

13. The lens driving device according to claim 12, further comprising a circuit board connected to a lower surface of the top plate of the housing, wherein the second coil unit and the third coil unit comprise coils integrally formed within the circuit board.

14. The lens driving device according to claim 5, further comprising a plurality of linear springs connected between the top plate of the housing and the second carrier; the plurality of linear springs are configured for supporting the second carrier to move perpendicular to the optic axis of the first lens unit.

15. The lens driving device according to claim 14, further comprising a plurality of plate springs connected to lower ends of the plurality of linear springs;
wherein the plurality of plate springs are also connected to lower ends of the plurality of side fixing portions.

16. The lens driving device according to claim 5, wherein the second carrier further comprises a second lens barrel extending upwardly from the base plate and configured for holding a second lens unit; the first lens unit and the second lens unit are coaxial.

17. The lens driving device according to claim 16, wherein the second lens barrel protrudes out of the first opening.

18. The lens driving device according to claim 17, wherein an upper part of the first lens barrel is inserted in the second lans barrel.

19. A camera, comprising:
a first lens unit;
a reflective lens; and
a lens driving device according to claim 1.

20. An electronic device, comprising a camera according to claim 19.
